(19) United States
(12) Patent Application Publication
(10) Pub. No.: US 2012/0000562 A1
(43) Pub. Date: Jan. 5, 2012

(54) BRAKE BOOSTER LINE

(75) Inventors: Botho HOFFMANN, Domat/Ems (CH); Ralph KETTL, Paspels (CH); Luc SCHERRER, Tamins (CH)

(73) Assignee: EMS-PATENT AG, Domat/Ems (CH)

(21) Appl. No.: 13/172,378

(22) Filed: Jun. 29, 2011

(30) Foreign Application Priority Data
Jun. 30, 2010 (EP) 10168030.4

(51) Int. Cl. F16L 11/00

(52) U.S. Cl. 138/118

(57) ABSTRACT

A partial vacuum brake booster line is produced from a polyamide blend molding compound having a polyamide blend component and an impact resistance component. The polyamide blend component of the polyamide blend molding compound comprises the following polyamides: (A) 25 to 65 wt.-% of at least one partially crystalline polyamide having a melt enthalpy of >40 J/g and having an average of at least 8 C atoms per monomer unit, selected from a group which consists of the polyamides PA 11, PA 610, PA 612, PA 1010, PA 106, PA 106/10T, PA 614, and PA 618; (B) 0 to 25 wt.-% of at least one amorphous and/or microcrystalline polyamide, the microcrystalline polyamide having a melt enthalpy in the range from 4 to 40 J/g; and (C) 1 to 55 wt.-% of at least one polyamide having an average of at most 6 C atoms per monomer unit. The impact resistance component is formed from: (D) 5 to 35 wt.-% of a non-polyamide elastomer or of a mixture of non-polyamide elastomers. All specifications in wt.-% relate to the total weight of the polyamide blend molding compound and add up, optionally supplemented by also added commercially available additives, to 100 wt.-%. In addition, the partial vacuum brake booster line according to the invention is implemented as a single-layer extruded pipe and has a modulus of elasticity of at least 50 MPa at +180° C. The average number of C atoms per monomer unit is calculated for the polyamides from the sum of the number of C atoms in the monomers used divided by the number of monomers used.

The present application claims priority under 35 U.S.C. §119(a) of European Application No. 10168030.4 filed Jun. 30, 2010, the disclosure of which is expressly incorporated by reference herein in its entirety.

The invention relates, according to the preamble of independent claim 1, to a partial vacuum brake booster line, which is produced from a polyamide blend molding compound having a polyamide blend component and an impact resistance component. Such molding compounds are suitable, inter alia, for producing lines in industrial and automobile applications, preferably for vacuum lines and particularly preferably for partial vacuum brake booster lines.

Plastic pipes made of polyamide are known and are used in greatly manifold ways in automotive engineering, for example, for brake, hydraulic, fuel, cooling, and pneumatic lines (cf. DIN 73378: “Rohre aus Polyamid für Kraftfahrzeuge [Pipes Made of Polyamide for Motor Vehicles]”). Polyamide blend molding compounds having a polyamide blend component and an impact resistance component are known from the patent application EP 1 942 296 A 1 in reference to the production of hydraulic lines, in particular clutch lines.

Plastic pipes or lines used in automotive engineering must fulfill manifold requirements. For the case of a brake booster line, their mode of operation can be described as follows:

To reduce the actuating force required to achieve a desired braking action, a brake booster is used on the brake of a vehicle. It is required in particular if disc brakes are used, because the actuation of the disc brakes of an automobile using the pedal pressure alone would require an excessive force application. In the case of the partial vacuum brake boosters which are predominantly installed in passenger automobiles and light utility vehicles, the auxiliary force is generated using a pressure differential (atmospheric pressure to partial vacuum). In the case of moderate to heavy utility vehicles (typically from 7.49 tons), such as trucks, the brake force is generated using compressed air, i.e., using an external force brake system; the operating pressure is approximately 8 bar here. In addition to these pneumatic brake boosters, hydraulic or electrical brake boosters are also known.

Motor vehicles having classical gasoline engines require the use of a throttle valve at part load in order to generate a combustible fuel-air mixture. As a side effect, a partial vacuum arises behind the throttle valve in the intake system (intake manifold). In the case of pneumatic brake boosters, the brake pedal pressure is boosted with the aid of the intake partial vacuum or a vacuum pump. In the case of current gasoline engines having direct gasoline injection, for example, in the VW TSI, a separate suction pump or partial vacuum pump (also vacuum pump) is required due to the system-related omission of the throttle valve, as is also the case for diesel engines (which fundamentally do not have a throttle valve). A check valve is installed in the connecting line between brake booster and partial vacuum source, which is used for the purpose of maintaining the partial vacuum at full load and when the engine is shut down. This partial vacuum represents a pressure gradient in relation to the outside air, which may be utilized in the brake booster to increase the brake force.

The vacuum or the partial vacuum is typically brought using pipelines from the vacuum generator to the brakes or to the brake booster (BKV). In order that it ensures perfect functioning of the brake booster in all possible weather and temperature conditions, inter alia, the following requirements must be fulfilled by a brake booster line:

1) Material requirements on flexible lines “TL 52655”, brake booster lines (VOLKSWAGEN AG): normal temperature range (continuous temperature T_{D}≦120° C.); high temperature range (continuous temperature T_{D}≦160° C.), sufficient strength up to at least +150° C. (short-term up to greater than +160° C.). On the other hand, brake booster lines must also function reliably at temperatures of −40° C. In addition, it is required that such brake booster lines be resistant to ozone and withstand repeated climate changes (having up to 20-60 cycles) without cracking.
2) Worldwide Engineering Standards for Low Pressure Pipe Assembly for Brake Boosters “GMW14640” (GENERAL MOTORS): type A normal temperature range −40° C. to +110° C. (maximum temperature up to +120° C.); type B high temperature range −40° C. to +140° C. (maximum temperature up to +150° C.). This applies for the line diameters 9±0.15×1.5±0.1 mm; 12±0.15×1.5±0.1 mm; and 12.5±0.15×1.25±0.1 mm.
3) Supplier guideline for pipes made of polyamide (PA) for the low pressure range “DBL 6270” (MERCEDES-BENZ): The pipes are subjected to heat aging over 1000 hours at storage temperatures of up to +150° C. and then tested for impact resistance according to ISO 179 at 23° C. and −40° C. In the new state of the pipes, an impact resistance test is performed at 23° C.; −40° C.; and −50° C. The burst pressure test is performed according to DIN 53 758. For brake booster lines, a characterization is performed according to DIN 73 378 and FMVSS106/74. For pipes in the field of compressed air brake systems, DIN 74 324-1 and DIN 74 324-2 additionally apply. For pipes as a partial vacuum line for operation of brake boosters (except for Unimog), the product specification A1 16 000 66 99 and the standard FMVSS 106 additionally apply.

In addition, the documents EP 1 329 481A2 and DE 103 33 005 A1 are known from the prior art. Both are concerned with lines for automotive engineering, mechanical engineering, and medical technology. Specifically, these documents are concerned with the production of partial vacuum lines for brake boosters, with ventilation lines, pressure hoses, compressed air lines, control lines, coolant lines, fuel lines, vent pipes, windshield washing system lines, lines for hydraulic clutch systems, power steering lines, air-conditioning lines, cable or core sheaths, and with injection-molded parts of an oil filter or a fuel filter. EP 1 329 481A2 discloses a molding compound which contains 99.9 to 95 weight-parts of a polyether amide based on a linear aliphatic diamine having 6 to 12 C atoms, a linear aliphatic or aromatic dicarboxylic acid having 6 to 12 C atoms, and a polyether diamine having at least 3 C atoms per ether oxygen and primary amino groups on the chain ends. This molding compound is supplemented to 100 weight-parts by 0.1 to 5 weight-parts of a copolymer made of various chemical components.

DE 103 33 005 A1 discloses a molding compound which contains 97 to 80 weight-parts of a polyether amide based on a linear aliphatic diamine having 6 to 14 C atoms, a linear aliphatic or aromatic dicarboxylic acid having 6 to 14 C atoms, and a polyether diamine having at least 3 C atoms per ether oxygen and primary amino groups on the chain ends. This molding compound is supplemented to 100 weight-parts by 3 to 20 weight-parts of a rubber containing functional groups.

In addition, the product VESTAMID® EX9350 black is known from the prior art (VESTAMID® is a registered trademark of EVONIK DEGUSSA GmbH). This is a heat-resistant and weather-resistant, impact-resistance-modified polyamide 612 elastomer for extrusion processing, e.g., in the production of pipelines, such as brake booster lines.

Blends of aromatic/aliphatic polyamides having various compositions are known from M. Xanthos et al. 1996 “Impact Modification of Aromatic/Aliphatic Polyamide Blends: Effects of Composition and Processing Conditions” (Journal of Applied Polymer Science, Vol. 62: 1167-1177). A polyamide blend molding compound having a polyamide component and at least one impact resistance component is disclosed, this polyamide blend molding compound comprising the following components:
32 wt.-% of an amorphous polyamide (PA 6I/6T) having an average of 7 C atoms per monomer unit;
48 wt.-% of a polyamide (nylon 6) based on lactam and/or amino carboxylic acid and having an average of 6 C atoms per monomer unit; and
20 wt.-% of an ethylene/propylene elastomer (EPX) which is functionalized by maleic acid anhydride.

A polyamide blend molding compound having a polyamide blend component and at least one impact resistance component is known from the document U.S. Pat. No. 5,928,738, the polyamide blend molding compound comprising the following components:
30 wt.-% of a polyamide 6/12 (Grilon CF6S) having an average of 9 C atoms per monomer unit;
10 wt.-% of an amorphous polyamide 6I/6T;
50 wt.-% of a polyamide 6 based on lactam and/or amino carboxylic acid and having an average of 6 C atoms per monomer unit; and
10 wt.-% ethylene/methacrylic acid elastomer.

A polyamide blend molding compound having a polyamide blend component and at least one impact resistance component is known from the document U.S. Pat. No. 6,416,832, the polyamide blend molding compound comprising the following components:
20 wt.-% of a polyamide 6/12/MXD6 having an average of 8 C atoms per monomer unit;
10 wt.-% of an amorphous polyamide;
50 wt.-% of a polyamide 6 based on lactam and/or amino carboxylic acid and having an average of 6 C atoms per monomer unit; and
20 wt.-% elastomers based on polyethylene (AAE and PE).

A polyamide blend molding compound having a polyamide blend component and at least one impact resistance component is known from the document US 2005/0009976 A1, the polyamide blend molding compound comprising the following components:
45 wt.-% of a polyamide MXD6 having an average of 7 C atoms per monomer unit;
25 wt.-% of an amorphous polyamide; and
30 wt.-% of a polyamide (PA6-NC2) based on lactam and/or amino carboxylic acid and having an average of 6 C atoms per monomer unit.

A polyamide blend molding compound having a polyamide component and at least one impact resistance component is known from the document US 2007/0089798 A1, the polyamide blend molding compound comprising the following components:
50 wt.-% of a polyamide polymetaxylylene adipamide (MXD6) having an average of 7 C atoms per monomer unit; and
50 wt.-% of a denatured polyamide 6 having an average of 6 C atoms per monomer unit having a modulus of elasticity of 830 MPa.

The production of a polyamide blend molding compound having a polyamide component and at least one impact resistance component is known from the document US 2004/0259996 A1, the polyamide blend molding compound comprising polyamides and polyester amides, nanoscale and fibrous fillers, and impact resistance modifiers. Ethylene propylene rubber (EPM) and ethylene propylene diene rubber (EPDM) are disclosed as impact resistance modifiers.

A reinforced polyamide composition having excellent flowability during injection molding having short cycle time is known from JP 2001-329165 A. The reinforced polyamide composition results in strong hot glued or solvent welded products and comprises 96-99.9 wt.-% of a crystalline polyamide, 0.1-4 wt.-% of a partially amorphous copolyamide having at least two aromatic monomer components, and 5-200 weight-parts of an inorganic filler per 100 weight-parts of the polyamide resin.

A molding compound based on polyamide is known from EP 1 942 296 A1, which is synthesized from a mixture made of the following components:
45-97 wt.-% of a polyamide 610 having an average of 8 C atoms per monomer unit;
0-30 wt.-% of an amorphous and/or microcrystalline polyamide and/or copolyamide;
2-20 wt.-% of an impact resistance component in the form of a copolymer based on ethylene and/or propylene; and
1-10 wt.-% additives.

It is disclosed in the document US 2004/0096615 A1, in the second part of paragraph [0113], that a blend made of polyamide 6, polyamide 12, and an impact resistance modifier, e.g., according to molding compound 5 in Table 1, is also well suitable as a hose material. According to paragraph [0002], this document relates to the use as a compressed air brake line.

A compressed air brake line is also disclosed in US 2009/0065085 A1. It comprises at least three layers. Adhesion promoter intermediate layers are optional. A mixture which comprises polyamide 612, polyamide 6, and an impact resistance modifier is specified as an example for the composition of an adhesion promoter layer in paragraph [0061].

A multilayer composite in the form of extruded hollow bodies is known from the document US 2008/0057246 A1. The corresponding multilayer pipes are preferably used as a fuel line. Compressed air brake lines are mentioned as an additional possible usage. The outer layer is a polyamide mixture having a polyamide elastomer. According to table 3, molding compound Z7873, a mixture made of polyamide 12, polyamide 6, and an impact resistance modifier, can be used for the inner layer.

A multilayer structure is known from the document US 2009/0269532 A1, which preferably has the form of a pipe, and is suitable for biodiesel or brake fluid. In Table 1, a three-layered pipe is disclosed in example 39, whose middle layer is an adhesion promoter layer made of a polyamide blend molding compound, which comprises polyamide 6, polyamide 12, and an impact resistance modifier.

An object of the present invention is to propose an alternative brake booster line, which is produced from a polyamide blend molding compound having a polyamide blend component and an impact resistance component, this alternative brake booster line to have at least comparable characteristic values as the brake booster lines known from the prior art.

This object is achieved according to the present invention by a partial vacuum brake booster line according to claim 1. This partial vacuum brake booster line according to the invention is produced from a polyamide blend molding compound having a polyamide blend component and an impact resistance component, the polyamide blend molding compound used being characterized in that the polyamide blend component comprises the following polyamides:
(A) 25 to 65 wt.-% of at least one partially crystalline polyamide having a melt enthalpy of >40 J/g and having an average of at least 8 C atoms per monomer unit, selected from a group which consists of the polyamides PA 11, PA 610, PA 612, PA 1010, PA 106, PA 106/10T, PA 614, and PA 618;
(B) 0 to 25 wt.-% of at least one amorphous and/or microcrystalline polyamide, the microcrystalline polyamide having a melt enthalpy in the range from 4 to 40 J/g; and
(C) 1 to 55 wt.-% of at least one polyamide having an average of at most 6 C atoms per monomer unit, and preferably having a melt enthalpy >40 J/g.

This polyamide blend molding compound for producing the partial vacuum brake booster line according to the invention is further characterized in that the impact resistance component is formed from:
(D) 5 to 35 wt.-% of a non-polyamide elastomer or of a mixture of non-polyamide elastomers.

All specifications in wt.-% relate to the total weight of the polyamide blend molding compound and add up, optionally supplemented by standard additives which are also added, to 100 wt.-%.

In addition, the partial vacuum brake booster line according to the invention is implemented as a single-layer extruded pipe and has a modulus of elasticity of at least 50 MPa at a temperature of +180° C.

The average number of C atoms per monomer unit is calculated for the polyamides from the sum of the number of C atoms in the monomers used divided by the number of monomers used.

Further features according to the invention and preferred embodiments result from the dependent claims.

The following definitions are listed in connection with the present invention:

The term “polyamide” is understood to include:

homopolyamides; and

copolyamides.

The term “polyamide blend” is understood to include:

mixtures (blends) of homopolyamides and copolyamides;

mixtures of homopolyamides; and

mixtures of copolyamides.

The term “polyamide molding compound” is understood to include a molding compound which contains polyamides and/or polyamide blends, wherein this polyamide molding compound can contain additives.

The term “structural unit” refers to the smallest unit which repeats in the chain of a polyamide, and which is composed of the amino carboxylic acid and/or the diamine and the dicarboxylic acid. A name which is synonymous with “structural unit” is the term “repetition unit”. Selected examples of such structural units are shown in Table 1:

TABLE 1

| | |
|---|---|
| PA 6 | 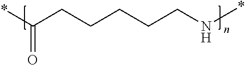 |
| PA 66 | 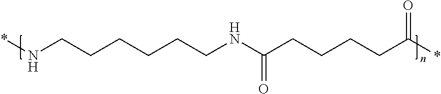 |
| PA 11 | 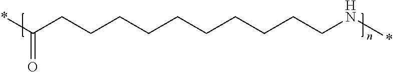 |
| PA 612 | 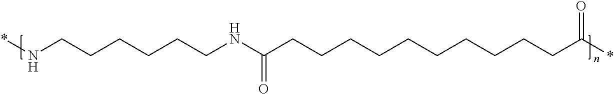 |
| PA 612/1012 | 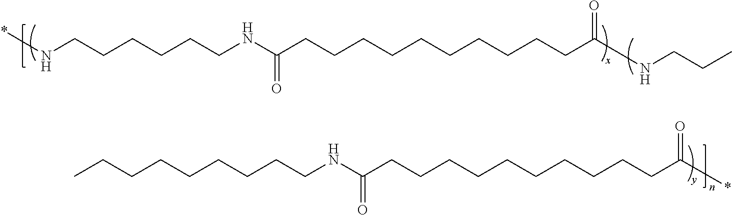 |

The structural unit is placed in square brackets and provided with the index n for each of these polyamides in Table 1. As is obvious, the structural unit of a polyamide of the so-called AA/BB type (e.g., PA 66 or PA 612) comprises more than one monomer unit, namely diamine and dicarboxylic acid monomer units, which supplement one another in each case.

The term “average (Ø) number of C atoms per monomer unit” is understood as the number of C atoms, which is calculated from the sum of the number of C atoms in the monomers used divided by the number of the monomers used; for example:

| | | |
|---|---|---|
| PA 6 | Ø 6 C atoms per monomer unit | [6 : 1 = 6] |
| PA 66 | Ø 6 C atoms per monomer unit | [(6 + 6) : 2 = 6] |
| PA 11 | Ø 11 C atoms per monomer unit | [11 : 1 = 11] |
| PA 612 | Ø 9 C atoms per monomer unit | [(6 + 12) : 2 = 9] |
| PA 612/1012 | Ø 10 C atoms per monomer unit | [((6 + 12) + |
| | | (10 + 12)) : 4 = 10]. |

The average (Ø) number of C atoms per monomer unit can also be a non-integer number.

Furthermore, it is defined in that polyamides are synthesized on the basis of linear and/or branched aliphatic and/or cycloaliphatic monomers, selected from the group diamines, dicarboxylic acids, lactams, and amino carboxylic acids. Diamines, dicarboxylic acids, lactams, and amino carboxylic acids are the four possible monomer types which are found as corresponding monomer units in the polyamides synthesized therefrom. One differentiates here between:
polyamides having an average of at least 8 C atoms per monomer unit, such as PA 11, PA 12, PA 412, PA 414, PA 418, PA 46/418, PA 610, PA 612, PA 614, PA 618, PA 106, and PA 106/10T;
amorphous and/or microcrystalline polyamides, the microcrystalline polyamide having a melt enthalpy in the range from 4 to 40 J/g, in particular in the range from 4 to 25 J/g; such as PA MACMI/MACMT/12, PA MACMI/12, and PA PACM12; and
polyamides having an average of at most 6 C atoms per monomer unit, such as PA 6, PA 46, and PA 66.

The monomers for producing the polyamides can be selected as follows:

Dicarboxylic acids can be selected from the following group: aliphatic C₄-C₄₄ dioic acids, cycloaliphatic C₈-C₃₆ dioic acids, aromatic dioic acids (preferably TPS, IPS, NDS), and mixtures and combinations thereof. Preferred dicarboxylic acids are selected from the group adipic acid, sebacic acid, dodecane dioic acid, terephthalic acid, isophthalic acid, cyclohexane dicarboxylic acid, and mixtures thereof, particularly preferably succinic acid, glutaric acid, adipic acid, pimelic acid, suberic acid, azelaic acid, sebacic acid, undecane dioic acid, dodecane dioic acid, brassylic acid, tetradecane dioic acid, pentadecane dioic acid, hexadecane dioic acid, heptadecane dioic acid, octadecane dioic acid, nonadecane dioic acid, eicosane dioic acid, Japanic acid, cyclohexane dicarboxylic acid, in particular cis- and/or trans-cyclohexane-1,4-dicarboxylic acid and/or cis- and/or trans-cyclohexane-1,3-dicarboxylic acid (CHDA), dimeric fatty acids having 36 or 44 C atoms, isophthalic acid, terephthalic acid, naphthalene dicarboxylic acid.
Diamines are preferably selected from the group of branched or unbranched aliphatic C₄-C₁₈ diamines, cycloaliphatic C₆-C₂₀ diamines, diamines having aromatic core, and mixtures and combinations thereof. Examples of linear or branched aliphatic diamines are 1,4-butane diamine, 1,5-pentane diamine, 2-methyl-1,5-pentane diamine (MPMD), 1,6-hexane diamine, 1,7-heptane diamine, 1,8-octane diamine (OMDA), 1,9-nonane diamine (NMDA), 1,10-decane diamine, 2-methyl-1,8-octane diamine (MODA), 2,2,4-trimethylhexamethylene diamine (NDT), 2,4,4-trimethylhexamethylene diamine (INDT), 5-methyl-1,9-nonane diamine, 1,11-undecane diamine, 2-butyl-2-ethyl-1,5-pentane diamine, 1,12-dodecane diamine, 1,13-tridecane diamine, 1,14-tetradecane diamine, 1,16-hexadecane diamine, trimethylhexamethylene diamine terephthalate (TMDT), isophorone diamine (IPD), and 1,18-octadecane diamine.
As cycloaliphatic diamines, for example, cyclohexane diamine, 1,3-bis-(aminomethyl)-cyclohexane (BAC), isophorone diamine, norbonane diamine, norbonane dimethylamine, bis(aminomethyl)norbonane, 4,4′-diaminodicyclohexylmethane (PACM), 2,2-(4,4′-diaminodicyclohexyl)propane (PACP), and 3,3′-dimethyl-4,4′-diaminodicyclohexylmethane (MACM) can be used. As arylaliphatic diamines, m-xylylene diamine (MXDA) and p-xylylene diamine (PXDA) are mentioned. All abbreviated names or abbreviations used correspond to ISO standards 1874-1 (cf. Table A.3: symbols for nonlinear aliphatic monomer units).
Lactams or amino carboxylic acids are preferably selected from the group which consists of caprolactam, laurin lactam, aminocapronic acid, aminolaurinic acid, and aminoundecanic acid. Lactams or α,ω-amino acids having 4, 6, 7, 8, 11, or 12 C— are preferred. These are the lactams pyrrolidine-2-one (4 C atoms), ε-caprolactam (6 C atoms), oenanthe lactam (7 C atoms), capryl lactam (8 C atoms), laurin lactam (12 C atoms), or the α,ω-amino acids 1,4-aminobutanoic acid (4 C atoms), 1,6-aminohexanoic acid (6 C atoms), 1,7-aminoheptanoic acid (7 C atoms), 1,8-aminooctanoic acid (8 C atoms), 1,11-aminoundecanoic acid (11 C atoms), and 1,12-aminododecanoic acid (12 C atoms).

A person skilled in the art knows which monomer types or what kinds of monomers are to be used for the production of the various polyamide types (homopolyamides of the type AA/BB or of the type AB, or for copolyamides).

The present invention is not obvious from the known prior art, because none of the above-cited documents proposes partial vacuum brake booster lines which are produced from a polyamide blend molding compound having a polyamide blend component and an impact resistance component according to the features of the present invention.

The present invention will be explained in greater detail on the basis of the appended figures, which merely illustrate the invention on the basis of examples, but are not to restrict it. In the figures:

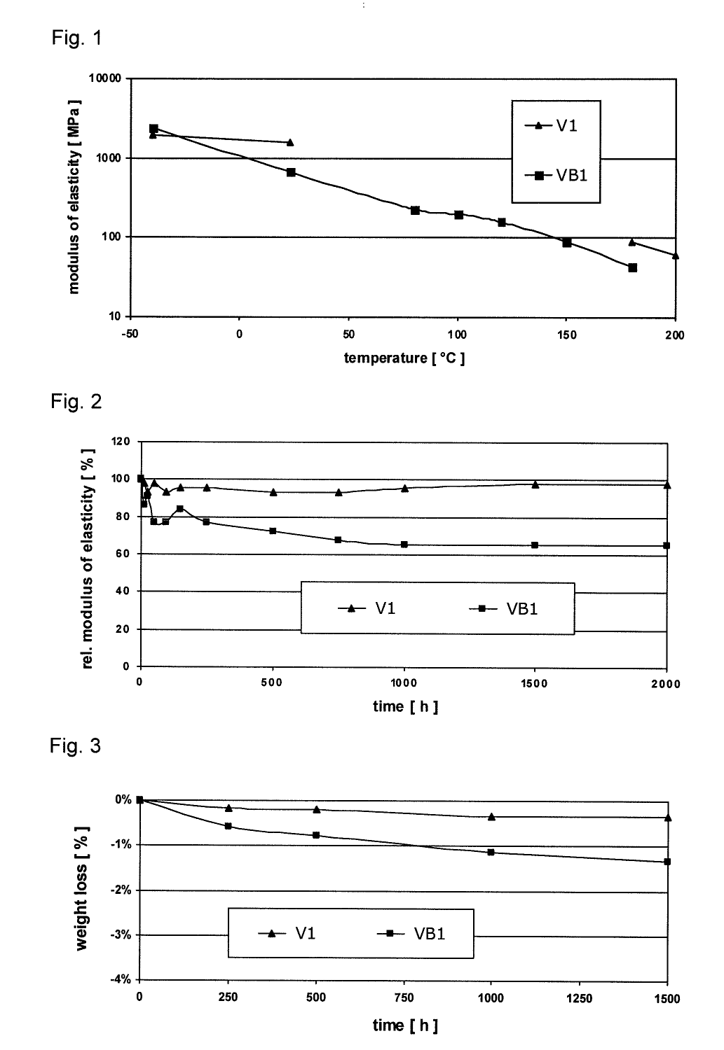

FIG. 1 shows a logarithmic graph of the modulus of elasticity measured on molded bodies produced using molding compound according to the invention and using comparison molding compounds at various temperatures;

FIG. 2 shows a graph of the relative modulus of elasticity as a function of time measured on molded bodies produced using molding compounds according to the invention and using comparison molding compounds at +150° C.;

FIG. 3 shows a graph of the weight loss as a function of time measured on molded bodies produced using molding compounds according to the invention and using comparison molding compounds at +150° C.

FIG. 1 shows the moduli of elasticity as a function of the temperature. The comparative example 1 (VB1), which is preferably used for applications such as BKV lines, displays an approximately linear curve here having a modulus of elasticity of approximately 2414 MPa at −40° C., approximately 669 MPa at +23° C., approximately 200 MPa at +100° C., and approximately 43 MPa at +180° C.

The experiment V1 according to the invention displays a modulus of elasticity of approximately 2000 MPa at −40° C., approximately 1580 MPa at +23° C., approximately 90 MPa at +180° C., and of approximately 60 MPa at +200° C. For the experiment V1 according to the invention, lower values for the modulus of elasticity were observed at lower temperatures than in the comparative example VB1. In contrast thereto, higher values for the modulus of elasticity were observed at higher temperatures for the experiment V1 according to the invention than in the comparative example VB1.

FIG. 2 shows the relative modulus of elasticity as a function of time. At hour 0, the relative modulus of elasticity is at 100% in all experiments. While the relative modulus of elasticity has already dropped to 86% after 12 hours in the comparative example VB1, the relative modulus of elasticity is still over 97% in the example V1 according to the invention. After 48 hours, the relative modulus of elasticity drops in the comparative example VB1 to approximately 80%, a value which the example according to the invention never reaches. All experiments display values at an approximately uniform level after approximately 750 hours, the relative modulus of elasticity approaching a value of approximately 65% in the comparative example VB1, while the relative modulus of elasticity in the example V1 according to the invention never drops below 92% and practically reaches the starting value of 100% again at 2000 hours.

FIG. 3 shows the weight loss as was measured on molded bodies produced using molding compounds produced according to the invention or using comparison molding compounds at +150° C. as a function of time. At hour 0, the weight loss is 0% in all experiments. While the weight loss in the comparative example VB1 is already 0.57% after 250 hours, the example V1 according to the invention only loses 0.11% in the first 250 hours. While the weight loss increases practically continuously in the comparative example VB1 and is 1.34% after 1500 hours (VB1), the weight appears to stabilize after 1000 hours at the level of a weight loss of approximately 0.33% to 0.35% in the example V1 according to the invention.

It can thus be shown on the basis of FIGS. 1 to 3 that the alternative partial vacuum brake booster lines produced according to the invention from a polyamide blend molding compound having a polyamide blend component and an impact resistance component have at least comparable, very often even better characteristic values than the brake booster lines known from the prior art.

A “blow by test” which was also performed according to the guidelines VW PV3936 has the result that test bodies (VB1) implemented according to the prior art display cracks on the surface, while test bodies (V1) produced according to the invention from a polyamide blend molding compound having a polyamide blend component and an impact resistance component did not display any cracks of the surface.

The component A of the polyamide blend component of the molding compound for the production according to the invention of alternative partial vacuum brake booster lines from a polyamide blend molding compound having a polyamide blend component and an impact resistance component is polyamides having an average of at least 8 C atoms per monomer unit. These polyamides are synthesized on the basis of linear and/or branched aliphatic and/or cycloaliphatic and/or aromatic monomers and are selected from the group PA 11, PA 610, PA 612, PA 1010, PA 106, PA 106/10T, PA 614, and PA 618, or mixtures thereof.

If a partially crystalline polyamide of the component A is used, this partially crystalline polyamide has a melt enthalpy of >40 J/g.

If a microcrystalline polyamide or copolyamide of component B is used, this microcrystalline polyamide and/or copolyamide has a melt enthalpy in the range from 4 to 40 J/g, preferably in the range from 4 to 25 J/g (measured using Differential Scanning calorimetry, DSC). Preferably, such a microcrystalline polyamide/copolyamide is a polyamide which results in transparent molded parts when processed without further components.

Microcrystalline polyamides are synthesized from aliphatic, cycloaliphatic, and/or aromatic monomers and comprise both homopolyamides and also copolyamides. Microcrystalline polyamides are no longer completely amorphous, but because of their microcrystalline structure they have crystallites, which are smaller than the wavelength of the light and are therefore not visible. Microcrystalline polyamides are therefore still transparent to the eye.

Transparent homopolyamides such as PA MACM12 and PA PACM12 and the transparent copolyamides PA 12/MACMI and PA MACM12/PACM12 as well as mixtures or blends thereof are particularly preferred for component B. PA MACMI/MACMT/12, which is known from WO 2007/087896 A1, is very specially preferred for component B.

The polyamide PA MACMI/MACMT/12 of component B is preferably formed from:

30 to 45 weight-parts MACMI,

30 to 45 weight-parts MACMT, and

10 to 40 weight-parts LC12.

According to a preferred embodiment, component B is an amorphous and/or microcrystalline polyamide and/or copolyamide based on a cycloaliphatic diamine and/or a diamine having aromatic core (e.g., MXDA or PXDA). This polyamide is preferably synthesized on the basis of cycloaliphatic diamines and aliphatic dicarboxylic acids having 10 to 18 carbon atoms. The cycloaliphatic diamine is especially preferably MACM and/or PACM and/or IPD (isophorone diamine) with or without additional substituents. This component B as a whole is particularly preferably a copolyamide of the type MACM/PACM, which has aliphatic dicarboxylic acids having 10 to 18 carbon atoms such as MACM12/PACM12 in each case. A PACM concentration of greater than 55 mol-%, in particular greater than 70 mol-%, is very particularly preferred. MACM stands for the ISO designation bis-(4-amino-3-methyl-cyclohexyl)-methane, which is commercially available under the trade name 3,3′-dimethyl-4,4′-diaminodicyclohexylmethane as Laromin® C260 type (CAS No. 6864-37-5). The number after the term MACM stands in each case for an aliphatic linear dicarboxylic acid (C12, e.g., DDS, dodecane dioic acid), with which the diamine MACM is polymerized. PACM stands for the ISO designation bis-(4-aminocyclohexyl)-methane, which is commercially available under the trade name 4,4′-diaminodicyclohexylmethane as Dicykan type (CAS No. 1761-71-3).

Alternatively or additionally, as already explained, component B can be an amorphous polyamide and/or copolyamide, which preferably has a melt enthalpy of less than 4 J/g (measured using Differential Scanning calorimetry, DSC). The component B preferably has a glass transition temperature which is above +120° C., preferably above +140° C., and particularly preferably above +150° C.

In a further preferred embodiment, component B is an amorphous polyamide and/or copolyamide based on aliphatic and/or cycloaliphatic diamines. Amorphous polyamides of the type MACMI/12 are preferably used, the content of Laurin lactam in this case preferably being less than 35 mol-%, in particular less than 20 mol-% ist. I stands for isophthalic acid in each case. Component B may thus be a polyamide based on aromatic dicarboxylic acids having 8 to 18 carbon atoms, or aliphatic dicarboxylic acids having 6 to 36 C atoms, or a mixture of such homopolyamides and/or copolyamides. In contrast, a polyamide based on lactams and/or amino carboxylic acids is preferred, the aromatic dicarboxylic acids being, for example, TPS (terephthalic acid) and/or IPS (isophthalic acid). The (transparent) homopolyamide and/or copolyamide can advantageously be a polyamide which is selected from the group comprising: PA 6I/6T, PA TMDT, PA NDT/INDT, PA 6I/MACMI/MACMT, PA 6I/PACMT, PA 6I/6T/MACMI, PA MACMI/MACM36, and PA 6I; lactam-containing polyamides such as PA 12/PACMI, PA 12/MACMI, PA 12/MACMT, PA 6/6I, and PA 6/IPDT, and an arbitrary mixture of these polyamides. Further possible systems are: PA MACM12, PA MACM18, or PA PACM12, PA MACM12/PACM12, PA MACM18/PACM18, PA 6I/PACMI/PACMT, or mixtures formed therefrom. The designation or abbreviation of the polyamides is performed according to ISO 1874-1 (cf. above in the description of individual monomers). For example, in each case I stands for isophthalic acid and T for terephthalic acid, TMD for trimethylhexamethylene diamine, and IPD for isophorone diamine.

Furthermore, it is advantageous and possible that the homopolyamide and/or copolyamide is a polyamide based on at least one dicarboxylic acid and at least one diamine having an aromatic core, preferably based on MXD (meta-xylylene diamine), the dicarboxylic acid can be aromatic and/or aliphatic, and preferably the polyamide being PA 6I/MXDI, for example.

Component C of the polyamide blend component of the molding compound for the production according to the invention of alternative brake booster lines from a polyamide blend molding compound having a polyamide blend component and an impact resistance component is polyamides having an average of at most 6 C atoms per monomer unit, such as PA 6, PA 46, and PA 66. These polyamides are partially crystalline.

The polyamide blend molding compound for producing the partial vacuum brake booster line according to the invention is preferably characterized in that component D is an ethylene-α-olefin copolymer, particularly preferably an EPM and/or EPDM elastomer (ethylene-propylene rubber or ethylene-propylene-diene rubber, respectively). It can thus be an elastomer, for example, which is based on an ethylene-C₃₋₁₂-α-olefin copolymer, which contains 20 to 96 wt.-% ethylene and preferably 25 to 85 wt.-% ethylene. A C₃₋₁₂-α-olefin selected from the group propene, 1-butene, 1-pentene, 1-hexene, 1-octene, 1-decene, and/or 1-dodecene is especially preferred, the ethylene component particularly preferably being ethylene-propylene rubber and/or LLDPE (Linear Low Density Polyethylene) and/or VLDPE (Very Low Density Polyethylene).

Alternatively or additionally (for example in a mixture), component D can be a terpolymer based on ethylene —C₃₋₁₂-α-olefin with an unconjugated diene, which preferably contains 25 to 85 wt.-% ethylene and up to at most in the range of 10 wt.-% of an unconjugated diene. The C₃₋₁₂-α-olefin is especially preferably an olefin selected from the group propene, 1-butene, 1-pentene, 1-hexene, 1-octene, 1-decene, and/or 1-dodecene, and/or the unconjugated diene is preferably selected from the group bicyclo(2.2.1)heptadiene, hexadiene-1.4, dicyclopentadiene, and/or in particular 5-ethylidene norbornene.

In addition, ethylene-acrylate copolymers also come into consideration for component D. Examples of ethylene-acrylate copolymers are: ethylene-methylacrylate-glycidyl methacrylate terpolymers, commercially available, e.g., from Arkema (FR) under the trade name Lotader GMA, or ethylene-acrylate-maleic acid anhydride terpolymers, commercially available, e.g., from Arkema (FR) under the trade name Lotader MAH. Further possible forms for component D are also ethylene-butylene copolymers, nitrile rubbers (e.g., NBR, H-NBR), silicone rubbers, EVA, and micro-gels, which are described in WO 2005/033185 A1, and/or mixtures (blends) which contain such systems.

Component D preferably has acid anhydride groups, which, by thermal or radical reaction of the main chain polymer with an unsaturated dicarboxylic acid anhydride, an unsaturated dicarboxylic acid, or an unsaturated dicarboxylic acid monoalkyl ester, are brought into in a concentration which is sufficient for good bonding to the polyamide. For this purpose, reagents are preferably selected from the following group: maleic acid, maleic acid anhydride, maleic acid monobutyl ester, fumaric acid, aconitic acid, and/or itaconic acid anhydride. Preferably, 0.1 to 4.0 wt.-% of an unsaturated anhydride is grafted onto the impact resistance component D, or the unsaturated dicarboxylic acid anhydride or its precursor is grafted together with a further unsaturated monomer. In general, the degree of grafting is preferably in a range from 0.1-1.0%, particularly preferably in a range from 0.3-0.7%.

A mixture of an ethylene-propylene copolymer and an ethylene-butylene copolymer is also possible as a preferred component D, this having a maleic acid anhydride degree of grafting (MAH degree of grafting) in the range from 0.3-0.7%. Such a product is available under the designation “Tafmer MC201” from Mitsui Chemicals (JP).

The above-specified possible systems for component D can also be used in mixtures.

Commercially available additives, such as stabilizers (e.g., UV and heat stabilizers (inorganic and organic)), softeners, radical scavengers, nucleation agents, processing aids, colorants, flame retardants, fillers, functional materials, lubricants, antistatic agents (e.g., carbon black), reinforcing agents (e.g., glass fibers, carbon fibers, mica, glass beads), and/or pigments or combinations or mixtures thereof are admixed with the polyamide blend molding compound as required. For the glass fibers, those having round (circular) cross-section and/or those having flat (noncircular) cross-section may be used.

An especially preferred partial vacuum brake booster line is characterized in that the polyamide blend component comprises the following polyamides:

### (A) 55 to 65 wt.-% PA 610; and

### (C) 10 to 20 wt.-% PA 6.

A partial vacuum brake booster line which is also preferred is characterized in that the polyamide blend component comprises the following polyamides:
25 to 50 wt.-% of the at least one partially crystalline polyamide of component (A);
5 to 20 wt.-% of the at least one amorphous and/or microcrystalline polyamide of component (B); and
5 to 20 wt.-% of the at least one polyamide of component (C).

For example, a method for producing polyamide nanocomposites is known from European patent application EP 1 416 010 A2, according to which organically modified layered silicates can be adjusted in the melt of the polyamide nanocomposite up to a final concentration of these layered silicates of at most 10 wt.-% (preferably from 2.5 to 6 wt.-%). Exfoliated layered silicates having a mean particle size of at most 100 nm were used as the mineral. The preferably used phyllosilicates (layered silicates) of the three-layer type (2:1) include mica (e.g., muscovite, paragonite, phologopite, biotite, lepidolite, margarite), smectite (montmorillonite, hectorite), and vermiculite. Such organically modified layered silicates can be used as reinforcing agents in injection molded parts, or also in extruded pipes.

A preferred partial vacuum brake booster line is accordingly characterized in that a filler is admixed with the blend, which is selected from a group which comprises fibers and organically modified layered silicates, the fibers also being able to be implemented as flat glass fibers, the polyamide blend molding compound being admixed with up to 20 wt.-% flat glass fibers, and the organically modified layered silicates being selected from a group which comprises mica, smectite, and vermiculite, the polyamide blend molding compound being admixed with up to 15 wt.-% organically modified layered silicates.

The preferred polyamide blend molding compound may be processed using the known techniques into smooth pipes and corrugated pipes, for example, classic pipe extrusion, corrugated pipe extrusion, or extrusion blow-molding, in single layers or multiple layers. According to the invention, the polyamide blend molding compound is used to produce single layered extruded pipes.

Extruded partial vacuum brake booster pipes can, alternatively or additionally to round or flat glass fibers and/or layered silicates, be admixed with further fillers, such as glass beads, talcum, CaCO₃ or kaolin particles.

The following chemical systems were used:

Component A=partially crystalline polyamides having an average of at least 8 C atoms per monomer unit:
PA 610: polyamide 610 with ηᵣₑₗ=1.9-2.25, EMS-CHEMIE AG, Switzerland
PA 612: polyamide 612 with ηᵣₑₗ=2.0-2.25, EMS-CHEMIE AG, Switzerland
   Component B=amorphous and/or microcrystalline polyamide:
PA MACMI/MACMT/12: amorphous polyamide with ηᵣₑₗ=1.5-1.6 and with T_{g}=+190° C., EMS-CHEMIE AG, Switzerland
   Component C=polyamides having an average of at most 6 C atoms per monomer unit:
PA 6: polyamide 6 with ηᵣₑₗ=3.35-3.5, EMS-CHEMIE AG, Switzerland
PA 66: RADIPOL A45, Radici Chimica, Italy (polyamide 66 with ηᵣₑₗ=2.7)

Impact Resistance Component:

Component D=non-polyamide elastomer:
non-polyamide elastomer: Tafmer MC201, Mitsui Chemicals, Japan (mixture of ethylene-propylene copolymer and ethylene-butylene copolymer grafted with maleic acid anhydride).

The production of so-called compounds or polyamide blend molding compounds is performed on a dual-shaft extruder Leistritz Micro27 (d=27 mm, L/D=40, 10 housing). All components of the polyamide blend molding compound according to the invention were dosed into the intake (zone 1). The molding compounds were produced and granulated at a screw speed of 150-200 RPM (rotations per minute) and cylinder temperatures in the range from +100 to +300° C. at a throughput of 12 kg/hour. Before the further processing, the granules were dried at 80° C. for 24 hours.

Subsequently, these mixtures were processed on an Arburg Allrounder 320-210-750 (Hydronica) injection molding machine into the required samples, the cylinder temperatures being between +220 and +280° C. and the mold temperature being between +20 and +80° C. The screw speed was 150 to 400 RPM.

The production of the test pipes in the dimensions 9×1.5 mm-12.5×2.1 mm was performed on a Nokia-Maillefer pipe extrusion system, comprising at least one extruder, a pipe die, a calibrating device with vacuum tank, as well as a cooling bath and a draw-off and cutting device downstream.

The polyamide molding compounds used are dried for approximately 8 hours at +80° C. before the pipe production. The pre-dried material is conveyed via a funnel into a three-zone screw, melted at cylinder temperatures of +220 to +280° C. (compound temperature: +240 to +280° C.), and homogenized, and discharged via a so-called pipe die. The still plastic preform is drawn using a draw-off device through a calibration (e.g., a sleeve calibration), where the preform is shaped in the calibration in the vacuum tank (total pressure: 100 to 900 mbar). The molded pipe is cooled for a longer or shorter period of time depending on the draw-off speed (the length of the cooling section is preferably 5 to 20 m). After the desired cooling or cooling section (cooling bath temperature: +10 to +20° C.), the pipe is coiled or cut. The draw-off speed is between 20-100 in/minute. The individual compositions are compiled in Tables 2 to 4 and 5 and 6.

The measurements were performed according to the following standards and on the following samples:
Tensile modulus of elasticity: ISO 527 at a traction speed of 1 mm/min; ISO tension rod, standard: ISO/CD 3167, type A1, 170×20/10×4 mm,
   temperature: −40° C., +23° C., +80° C., +100° C.; +120° C., +150° C., and +200° C. (cf. FIG. 1).
Tear strength and elongation at tear: ISO 527 at a traction speed of 50 mm/min; ISO tension rod, standard: ISO/CD 3167, type A1, 170×20/10×4 mm,
   temperature +23° C.
Impact strength as per Charpy: ISO 179/*eU; ISO tension rod, standard:
   ISO/CD 3167, type 91, 80×10×4 mm,
   temperature +23° C.;
   *1=not instrumented,
   *2=instrumented.
Notched impact strength as per Charpy: ISO 179/*eU; ISO tension bar, standard:
   ISO/CD 3167, type 91, 80×10×4 mm,
   temperature +23° C. respectively −30° C.;
   *1=not instrumented,
   *2=instrumented.
Glass transition temperature (T_{g}): ISO standard 11357-11-2; granules
Melting temperature (Lₘ): ISO standard 11357-11-2; granules
melt enthalpy (ΔH): ISO standard 11357-11-2; granules
Burst pressure on pipes: DIN 73378; +23° C.

Differential Scanning calorimetry (DSC) was performed at a heating rate of 20 K/min.

The relative viscosity was measured according to DIN EN ISO 307, for PA 610, PA 612, amorphous PA, polyamide elastomer, and compounds in 0.5 wt.-% m-cresol solution (i.e., 0.5 g PA in 100 ml solution), at a temperature of +20° C.; for PA 6 in 1 wt.-sulfuric acid solution (i.e., 1 g PA in 100 ml solution). The MVR (Melt Volume Rate) was measured according to ISO 1133 at +275° C.

The partial vacuum strength is determined in that a partial vacuum of 940 mbar is applied and the temperature is then slowly increased. The temperature at which the pipe collapses is measured. The modulus of shear curves were recorded on samples having the dimensions 40×10×1 mm on a Physica MCR301 from Anton Paar at a deformation of 1.5% and a frequency of 1 Hz and a heating rate of 4 K/min.

If not otherwise noted in the tables, the samples for the tensile experiment were used in the dry state. For this purpose, the samples were stored in a dry environment for at least 48 hours at room temperature after the injection molding. The pipes were conditioned before the testing. Table 2 shows basic data for the molding compounds of the comparative examples VB1, VB2, and VB3.

TABLE 2

| Component | Conditions | | Unit | VB1 | VB2 | VB3 |
|---|---|---|---|---|---|---|
| VESTAMID | | | wt.-% | 100 | | |
| EX9350 | | | | | | |
| PA 610 | | | wt.-% | | 93.4 | 73.4 |
| PA MACMI/ | | | wt.-% | | | 20 |
| MACMT/12 | | | | | | |
| Non-polyamide | | | wt.-% | | 5 | 5 |
| elastomer | | | | | | |
| Masterbatch for | | | wt.-% | | 1.6 | 1.6 |
| black dyeing and | | | | | | |
| heat stabilization | | | | | | |
| Total | | | | 100 | 100 | 100 |
| H₂O content | | | wt.-% | 0.01 | 0.01 | 0.01 |
| Melting point | | | ° C. | 198 | 220 | 220 |
| Shore hardness D | | | | 66 | n.b. | n.b. |
| Tensile modulus | 1 | mm/min | MPa | 670 | 2340 | 2120 |
| Tension at 50% | 50 | mm/min | MPa | 29 | n.b. | n.b. |
| elongation | | | | | | |
| Impact Charpy | −30° | C. | kJ/m² | o.B. | o.B. | o.B. |
| Notch | 23° | C. | kJ/m² | 23 | 9 | 10 |
| impact Charpy | | | | | | |
| Notch | −30° | C. | kJ/m² | 6 | 9 | 9 |
| impact Charpy | | | | | | |

In the table: o.B. = without fracture; n.b. = not determined

VB1 is a polyamide 612 elastomer having a modulus of elasticity of 670 MPa and a Charpy notch impact of 23 kJ/m² measured at +23° C. In comparison, VB2 and VB3 are significantly stiffer, the modulus of elasticity is 2340 MPa or 2120 MPa and also the Charpy notch impact at +23° C. is lower at 9 or 10 kJ/m² than for VB1.

Table 3 shows basic data for the molding compounds of the experiments V1, V5, and V6 according to the invention.

TABLE 3

| Component | | Conditions | Unit | V1 | V5 | V6 |
|---|---|---|---|---|---|---|
| A | PA 610 | | wt.-% | 63.7 | 63.7 | 63.7 |
| B | PA MACMI/ | | wt.-% | 0 | 0 | 0 |
| | MACMT/12 | | | | | |
| C | PA 6 | | wt.-% | 12.75 | 15 | |
| C | PA 66 | | wt.-% | | | 15 |
| D | Non-polyamide | | wt.-% | 20.0 | 20.0 | 20.0 |
| | elastomer | | | | | |
| | Masterbatch for | | wt.-% | 3.55 | 1.3 | 1.3 |
| | black dyeing | | | | | |
| | and heat | | | | | |
| | stabilization | | | | | |

| | | | | | |
|---|---|---|---|---|---|
| Total | | | 100.0 | 100.0 | 100.0 |
| H₂O content | | wt.-% | 0.040 | 0.017 | 0.065 |
| Melting point | | ° C. | 222 | 220 | 221 |
| Shore hardness D | | | 72 | 69 | n.b. |
| Tensile modulus | 1 mm/min | MPa | 1610 | 1550 | 1860 |
| Tension at 50% | 50 mm/min | MPa | 40 | 38 | — |
| elongation | | | | | |
| Impact Charpy | −30° C. | kJ/m² | o.B. | o.B. | o.B. |
| Notch impact | +23° C. | kJ/m² | o.B. | 95 | 75 |
| Charpy | | | | | |
| Notch impact | −30° C. | kJ/m² | 22 | 23 | 18 |
| Charpy | | | | | |

In the FIGURE:
o.B. = without fracture;
n.b. = not determined

It can be shown by the data for the molding compounds of the experiments V1, V5, and V6 according to the invention that by suitable selection of the blend composition, the modulus of elasticity can be set between 1550 MPa and 1860 MPa. The modulus of elasticity measured at a temperature of −30° C. is preferably at most 2000 MPa. A partial vacuum brake booster line according to the invention has a modulus of elasticity of at most 2400 MPa, preferably at most 2000 MPa, and particularly preferably at most 1950 MPa at a temperature of −40° C.

Such partial vacuum brake booster lines additionally have a modulus of elasticity of at least 50 MPa, preferably at least 75 MPa, and particularly preferably at least 85 MPa at a temperature of +180° C.

The modulus of elasticity is significantly reduced in comparison to VB2 and VB3. The Charpy notch impact at +23° C. is also set ≧75 kJ/m² by the blends according to the invention, which is higher than for the comparative examples VB1-VB3. The significantly increased notch impact at a temperature of −30° C. in comparison to VB1-VB3 is particularly to be emphasized.

It is noted here that the polyamide PA MACMI/MACMT/12 mentioned in Tables 2 and 3 is available under the trade name Grilamid TR 60 from EMS-CHEMIE AG (Business Unit EMS-GRIVORY Europe, Domat/Ems, Switzerland).

Further measurements were performed on the pipes or samples produced from these molding compounds, the corresponding results are compiled in Tables 4 to 7.

Table 4 shows the modulus of elasticity measured on ISO tension rods at various temperatures (cf. also FIG. 1).

TABLE 4

| Conditions | Unit | VB1 | V1 | V5 | V6 |
|---|---|---|---|---|---|
| −40° C. | MPa | 2415 | 2000 | 1780 | n.b. |
| 23° C. | MPa | 670 | 1580 | 1550 | 1860 |
| 80° C. | MPa | 260 | n.b. | n.b. | n.b. |
| 120° C. | MPa | 150 | n.b. | n.b. | n.b. |
| 180° C. | MPa | 40 | 90 | 80 | 210 |
| 200° C. | MPa | n.m. | 60 | 55 | n.b. |

In the table: n.b. = not determined; n.m. = Not measurable, since VB1 has a melting point of +198° C.

The modulus of elasticity, which is reduced at −40° C. in comparison to VB1 with identical or higher modulus of elasticity at +180° C., is particularly to be emphasized.

Table 5 shows the heat aging of the ISO tension rods by storage at +150° C. and the relative elongation at fracture resulting therefrom of these ISO tension rods.

TABLE 5

| Storage time [h] | Unit | VB1 | V1 |
|---|---|---|---|
| 12 | % | 100 | 100 |
| 48 | % | 75.3 | 95 |
| 96 | % | 81.6 | 86 |
| 250 | % | 96.5 | 63 |
| 500 | % | 59.0 | 53 |
| 750 | % | 41.3 | 57 |
| 1000 | % | 30.4 | 57 |
| 1500 | % | 21.9 | 49 |
| 2000 | % | 19.8 | 41 |

While the elongation at fracture continuously decreases in the example V1 according to the invention, it rises once again in the prior art (VB1) at 96 and 250 hours before it then decreases very rapidly. The especially preferred example V1 according to the invention still displays a relative extension at fracture of greater than 40% after 2000 storage hours at +150° C. and thus a value which is approximately double that of comparative example VB1.

Table 6 shows the heat aging of ISO tension rods by storage at +150° C. and the impact strength (Charpy impact) of these ISO tension rods resulting therefrom.

TABLE 6

| Storage time [h] | Unit | VB1 | V1 |
|---|---|---|---|
| 0 | 100 kJ/m² | o.B. | o.B. |
| 250 | 100 kJ/m² | o.B. | o.B. |
| 500 | 100 kJ/m² | o.B. | o.B. |
| 750 | 100 kJ/m² | o.B. | o.B. |
| 1000 | 100 kJ/m² | 90 | o.B. |
| 1500 | 100 kJ/m² | 80 | o.B. |

In the table: o.B. = without fracture

Up to a storage time of 750 hours, the ISO tension rods of all studied samples (VB1, V1) do not break. While the ISO tension rods (V1) produced according to the invention also do not break after a storage of over 1000 hours at a temperature of +150° C., the ISO tension rods from the prior art (VB1) do not withstand this stress.

1. A partial vacuum brake booster line, produced from a polyamide blend molding compound having a polyamide blend component and an impact resistance component,
characterized in that the polyamide blend component of the polyamide blend molding compound comprises the following polyamides:
(A) 25 to 65 wt.-% of at least one partially crystalline polyamide having a melt enthalpy of >40 J/g and having an average of at least 8 C atoms per monomer unit, selected from a group which consists of the polyamides PA 11, PA 610, PA 612, PA 1010, PA 106, PA 106/10T, PA 614, and PA 618;
(B) 0 to 25 wt.-% of at least one amorphous and/or microcrystalline polyamide, the microcrystalline polyamide having a melt enthalpy in the range from 4 to 40 J/g; and
(C) 1 to 55 wt.-% of at least one polyamide having an average of at most 6 C atoms per monomer unit;
the impact resistance component is formed from:
(D) 5 to 35 wt.-% of a non-polyamide elastomer or of a mixture of non-polyamide elastomers;
all specifications in wt.-% relating to the total weight of the polyamide blend molding compound and adding up to 100 wt.-%, optionally supplemented by commercially available additives which are also added;
and the partial vacuum brake booster line is implemented as a single-layer extruded pipe and has a modulus of elasticity of at least 50 MPa at a temperature of +180° C.;
the average number of C atoms per monomer unit being calculated from the sum of the number of C atoms in the monomers used divided by the number of monomers used.

2. The partial vacuum brake booster line according to claim 1, characterized in that the microcrystalline polyamide of component (B) has a melt enthalpy in the range from 4 to 25 J/g.

3. The partial vacuum brake booster line according to claim 1, characterized in that the polyamide blend component comprises the following polyamides:
25 to 50 wt.-% of the at least one partially-crystalline polyamide of component (A);
5 to 20 wt.-% of the at least one amorphous and/or microcrystalline polyamide of component (B); and
5 to 20 wt.-% of the at least one polyamide of component (C).

4. The partial vacuum brake booster line according to claim 1, characterized in that at least one amorphous and/or microcrystalline polyamide of component (B) is selected from a group which comprises PA MACMI/MACMT/12, PA MACMI/12, and PA PACM12, PA 6I/6T, PA TMDT, PA NDT/INDT, PA 6I/MACMI/MACMT, PA 6I/6T/MACMI, PA MACM12/PACM12, PA MACMI/MACM36, PA 6I; PA 12/PACMI, PA 12/MACMI, PA 12/MACMT, PA 6I/PACMT, PA 6/6I, and PA 6/IPDT; PA MACM12, PA MACM18, PA PACM12, PA MACM12/PACM12, PA MACM18/PACM18, PA 6I/PACMI/PACMT; PA 6I/MXDI; as well as an arbitrary mixture of these polyamides.

5. The partial vacuum brake booster line according to claim 4, characterized in that the polyamide PA MACMI/MACMT/12 is formed from:
30 to 45 weight-parts MACMI,
30 to 45 weight-parts MACMT, and
10 to 40 weight-parts LC12.

6. The partial vacuum brake booster line according to claim 1, characterized in that at least one polyamide of component (C) having an average of at most 6 C atoms per monomer unit is selected from a group which comprises the polyamides PA 6, PA 46, and PA 66.

7. The partial vacuum brake booster line according to claim 1, characterized in that the polyamide blend component consists of the following polyamides:
(A) 55 to 65 wt.-% PA 610; and
(C) 10 to 20 wt.-% PA 6.

8. The partial vacuum brake booster line according to claim 1, characterized in that at least one of the non-polyamide elastomers of component (D) is selected from a group which comprises ethylene-α-olefin copolymers, ethylene-C₃₋₁₂-α-olefin copolymers, and ethylene-C₃₋₁₂-α-olefin with an unconjugated diene, NBR (acrylonitrile-butadiene rubber), and acrylate.

9. The partial vacuum brake booster line according to claim 8, characterized in that the ethylene-α-olefin copolymer is an EP elastomer (ethylene-propylene rubber) and/or EPDM elastomer (ethylene-propylene-diene rubber), the olefin of the ethylene-C₃₋₁₂-α-olefin copolymer being selected from the group propene, 1-butene, 1-pentene, 1-hexene, 1-octene, 1-decene, and/or 1-dodecene, and the unconjugated diene being selected from the group bicyclo(2.2.1)heptadiene, hexadiene-1,4, dicyclopentadiene, and 5-ethylidene norbornene.

10. The partial vacuum brake booster line according to claim 1, characterized in that a filler is admixed with the blend, which is selected from a group comprising fibers and organically modified layered silicates, the fibers being implemented as flat glass fibers, up to 20 wt.-% flat glass fibers being admixed with the polyamide blend molding compound, and the organically modified layered silicates being selected from a group which comprises mica, smectite, and vermiculite, the polyamide molding compound being admixed with up to 15 wt.-% organically modified layered silicates.

11. The partial vacuum brake booster line according to claim 1, characterized in that it has a modulus of elasticity of at most 2000 MPa at a temperature of −30° C.

12. The partial vacuum brake booster line according to claim 1, characterized in that it has a modulus of elasticity of at most 2400 MPa, preferably at most 2000 MPa, and particularly preferably at most 1950 MPa at a temperature of −40° C.

13. The partial vacuum brake booster line according to claim 1, characterized in that it has a modulus of elasticity of at least 75 MPa, preferably of at least 85 MPa at a temperature of +180° C.
